(19) United States
(12) Patent Application Publication
(10) Pub. No.: US 2017/0353531 A1
(43) Pub. Date: Dec. 7, 2017

(54) DATA CENTER PROFILING AND CLOUD EMULATION

(71) Applicant: Microsoft Technology Licensing, LLC, Redmond, WA (US)

(72) Inventor: Wilson G. Conn, Bellevue, WA (US)

(21) Appl. No.: 15/174,931

(22) Filed: Jun. 6, 2016

(51) Int. Cl. H04L 29/08

(52) U.S. Cl. CPC H04L 67/10; H04L 67/2861; H04L 67/288

(57) ABSTRACT

Disclosed herein are mechanisms and devices for profiling and emulating a data center in a cloud computing environment. A user requests the data center be emulated through a user interface. The user may supply various data center profile parameters detailing specific hardware, software, and operational information about the data center. A date center profiler profiles the data center requesting be emulated in order to uncover real-time processing and storage metrics of the data center. These metrics are used, along with any additional DC profile parameters specified by the user, by a cloud emulator to emulate the data center in the cloud computing environment. An emulated workload is created from the emulation of the data center, and cloud services for operating the data center in the cloud computing environment are detailed in an emulation report that is communicated back to the user.

### BACKGROUND

Cloud computing has become a vital resource in today's computer age. Corporate data centers that were solely managed by corporate enterprises are migrating into the cloud, fundamentally changing today's corporate computing landscape. No longer do companies need to buy expensive computing equipment and hire teams of information technology people to scale, reduce, and manage the data centers as the company's computing needs change. Instead, companies may use cloud-computing services offered by third parties that have as much computing capacity as the company needs.

Shifting the resources for data center management from the companies themselves into cloud environments offered by third parties has fundamentally changed how entities handle their corporate data centers. Data center resources are moving away from capital expenses (“capex”) in which the company itself must purchases, installs, services and manages data center computing resources (e.g., servers, administrators, etc.) and moving toward being operating expenses (“opex”) in which the company effectively rents outside computing resources and pays for the capacity the company needs. But moving corporate data centers to the cloud is often a monumental task, especially for large corporate customers with vast corporate data centers. Often, the company does not understand what their data center processing needs are, and third-party cloud companies offer a wide variety of services that are not necessarily ubiquitous across the cloud computing industry. Machines, storage, processing, software, service levels, redundancy, and a whole host of cloud-specific parameters vary widely between different vendors. Add in the fact that most corporate customers do not understand the processing and storage requirements necessary to operate their data centers, and one can easily see that migration into the cloud is an arduous task.

### SUMMARY

The disclosed examples are described in detail below with reference to the accompanying drawing figures listed below. The below Summary is provided to illustrate some examples disclosed herein. It is not meant, however, to limit all examples to any particular configuration or sequence of operations.

Aspects and examples disclosed herein are directed to automated profiling and emulation and emulation of a customer data center in order to determine cloud resources for operating the customer data center in the cloud computing environment. A data center profiler accesses the customer data center across a network and profile at least a portion of the customer data center to determine real-time workload data of the customer data center. This real-time workload data may include a quantity of computation cycles, a particular amount or type of storage, data redundancy metrics, data import/export information, or other processing and storage parameters of the customer data center. A cloud emulator uses the profiled real-time workload data to emulate the customer data center in the cloud computing environment, producing emulated cloud workload data. A suggestion engine uses the emulated cloud workload data to identify cloud resources that are available—or necessary—for operating the customer data center in the cloud computing environment. An emulation report that details necessary or possible resources for hosting the customer data center in the cloud environment is created and shared with users (e.g., customer or cloud representative) to aid in deciding whether to migrate the customer data center to the cloud environment.

### BRIEF DESCRIPTION OF THE DRAWINGS

The disclosed examples are described in detail below with reference to the accompanying drawing figures listed below:

FIG. 1 is a block diagram of an exemplary computing environment suitable for implementing the various examples disclosed herein;

FIG. 2 is a block diagram of an architecture for an exemplary cloud-computing infrastructure suitable for profiling and emulating customer data centers;

FIG. 3 is a block diagram of a networking environment for profiling and emulating customer data centers in a cloud computing environment;

FIG. 4 is a sequence diagram of a networking environment for profiling and emulating customer data centers in a cloud computing environment;

FIG. 5 is a relationship diagram of the various services, devices, and people interacting with the cloud emulator;

FIG. 6 is a flowchart diagram illustrating a work flow for emulating and profiling the customer data center; and

FIG. 7 is a flowchart diagram illustrating a work flow for emulating and profiling the customer data center.

Corresponding reference characters indicate corresponding parts throughout the drawings.

### DETAILED DESCRIPTION

The various embodiments will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

To aid the reader, the examples disclosed herein refer to a “customer” or “enterprise,” which represent a company or other legal entity, that operate a data center, and this customer-operated data center is aptly referred to herein as a “customer data center.” A “cloud company” refers to a third-party company that operates a “cloud computing environment,” which refers to a cloud-based network of servers—or other computing devices—that provide remote computer processing and storage resources for operating and managing data centers for other companies. In other words, the customers disclosed herein currently operate their own data customer centers and are considering migrating such operations to a cloud computing environment being managed by a cloud company.

Examples disclosed herein generally relate to emulating a customer data center in a cloud environment to identify the cloud resources needed to operate the customer data center therein. To do so, some the disclosed examples gather enterprise and data center parameters about the customer data center from a user (e.g., through a web site, device application, or other online portal). As described in more detail below, these enterprise and data center parameters may designate specifics about the customer data center (e.g., storage requirements, page views, types of software licenses, hybrid or dedicated server models, etc.) and/or specifics about the customer enterprise itself (e.g., company industry, number of software programmers, number of administrators, etc.). In some examples, this customer- or data-center-specific information is compared with other customer data centers in the cloud computing environment to estimate cloud resources, processing requirements, and storage needs of customer data center.

Additionally or alternatively, the customer data center may be profiled by a remote “data center (DC) profiler” (discussed in more detail below)—e.g., through a plug-in or application programming interface (API)—that monitors the current operations of the customer data center to retrieve real-time workload data. The real-time workload data may of the customer data center may indicate the computation cycles, types of storage being used, frequency of storage import/export operations, length of storage, storage capacity, socket-call logs, quantity and usage of data disks, input/output (I/O) load, response time, Transmission Control Protocol (TCP) logs and statistics (e.g., packet loss, receiver window limits, and the like), industry compliance metrics, application-generated microbursts, network congestion, or the like.

In some examples, a cloud emulator is used to emulate the customer data center in a cloud computing environment based on the real-time workload data of the customer data center. Such emulation allows the profiled customer data center to be modeled in the cloud environment without having to actually be migrated and hosted therein. Once the customer data center is emulated in the cloud computing environment, cloud resources needed for operating the customer data center in the cloud computing environment may be identified and suggested to the user. These cloud resources may include, for example but without limitation, specific software as a service (SaaS), platform as a service (PaaS), Infrastructure as a Service (IaaS), software licenses, data storage, redundancy, disk usage, node usage, VM provisioning or instantiation, processing capacity, or the like. In some examples, the identified cloud resources are specified in an emulation report that may be shared with the customer's or the cloud company's representative.

Conventional cloud-migration techniques do not allow for cloud resources to be automatically identified for a customer data center based on real-time workload data gathered through data center profiling. Using the actual and current workload data of the customer data center enables the disclosed examples to understand the real-time processing needs of a customer's data center and specifically tailor very precise suggestions for cloud resources to the customer. Actual selection of cloud resources to sign up for or use may be made by the customer, but the disclosed examples at least provide an automatically generated and easy-to-understand emulation report that suggests what cloud resources are available in the cloud computing environment to operate the customer data center in its current function.

Also, the disclosed examples emulate a currently operational customer data center in a cloud environment and then make recommendations based on this emulation. Doing so not only automates the suggestion process for determining which cloud resources to use (instead of having a cloud representative user manually identify the cloud services to offer the customer), but this emulation of real data ensures that the right cloud services are selected based on actual performance data of the data center. Using actual performance data of the data center removes the guesswork needed to fit the customer data center to the cloud computing environment and significantly streamlines the process of figuring out what services in the cloud computing environment are needed for the customer data center. Also, basing decisions on actual performance data ensures that customer is offered the cloud resources that are actually needed for operating the customer data center in the cloud computing environment, and not superfluous cloud resources that are unnecessary.

The emulation reports detail the cloud services needed for operating the customer data center in the cloud computing environment and are designed to facilitate meetings between the representative of the customer (“customer representative”) and the representative of the cloud computing company (“cloud representative”). The customer representative or the cloud representative may profile multiple data centers to understand what various configurations for moving the customer data center—or portions thereof—to the cloud. For example, the customer representative may generate three emulation reports: one for hosting only the web pages of a company in the cloud computing environment; one for hosing the web pages and a particular software product offered by the company (e.g., a music streaming service) in the cloud computing environment; and one for hosting the web pages, the particular software product, and all the company's customer data. With emulation reports detailing the cloud resources needed for each, the customer representative and the cloud representative can intelligently discuss various migration scenarios for the customer data center.

The examples disclosed herein refer to the customer data center being profiled for “real-time” workload data and the real-time time workload data being used to emulate the customer data center in the cloud. In this vein, some examples profile a customer data center to obtain processing and storage information of the data center at a particular point in time. Yet, examples are not limited to just point-in-time analytics of a customer data center. Alternative examples may profile the processing and storage of a customer data center to retrieve the DC workload data during a given time period over a certain amount of time. For example, the customer data center may be profiled for a present number of minutes, days, weeks, months, or the like. The DC workload data may be averaged over these time periods, or periods of high and low processing may be determined. The averages or high/low processing statistics may be used to emulate the customer data center in the cloud environment. Thus, examples may use real-time or historical workload data during cloud emulation. To aid the reader, the examples disclosed herein refer generally refer to “DC workload data,” which may include point-in-time processing and storage data of the customer data center (in some examples), historical processing and storage data of the customer data center (in some examples), or a combination thereof.

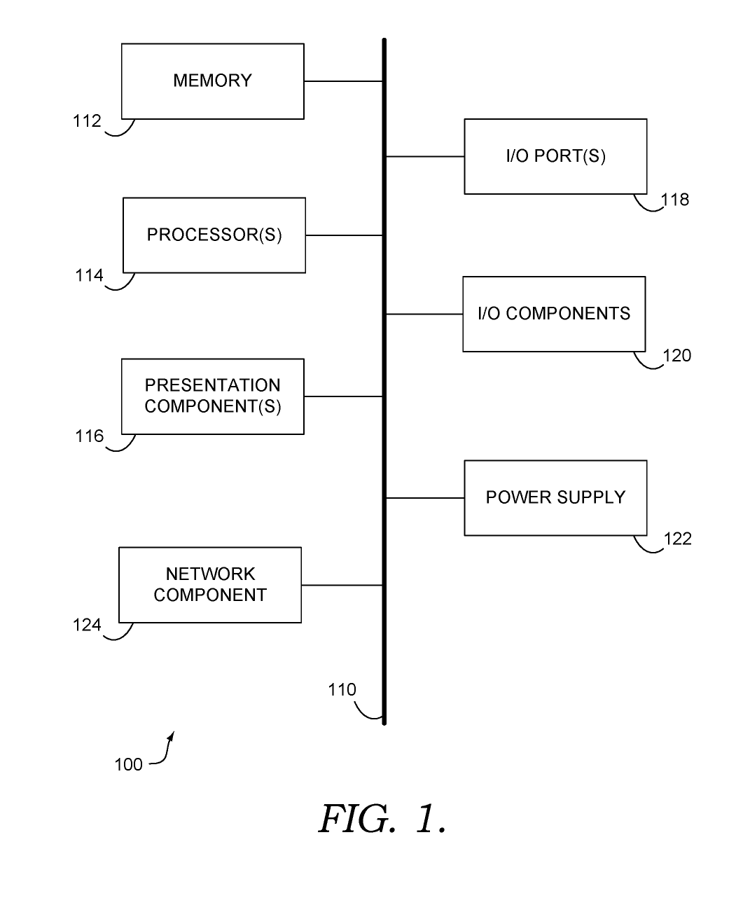

Having generally described some of the disclosed examples, attention is drawn to the accompanying drawings. Referring to the drawings in general, and initially to FIG. 1 in particular, an exemplary operating environment for implementing aspects disclosed herein is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components/modules illustrated.

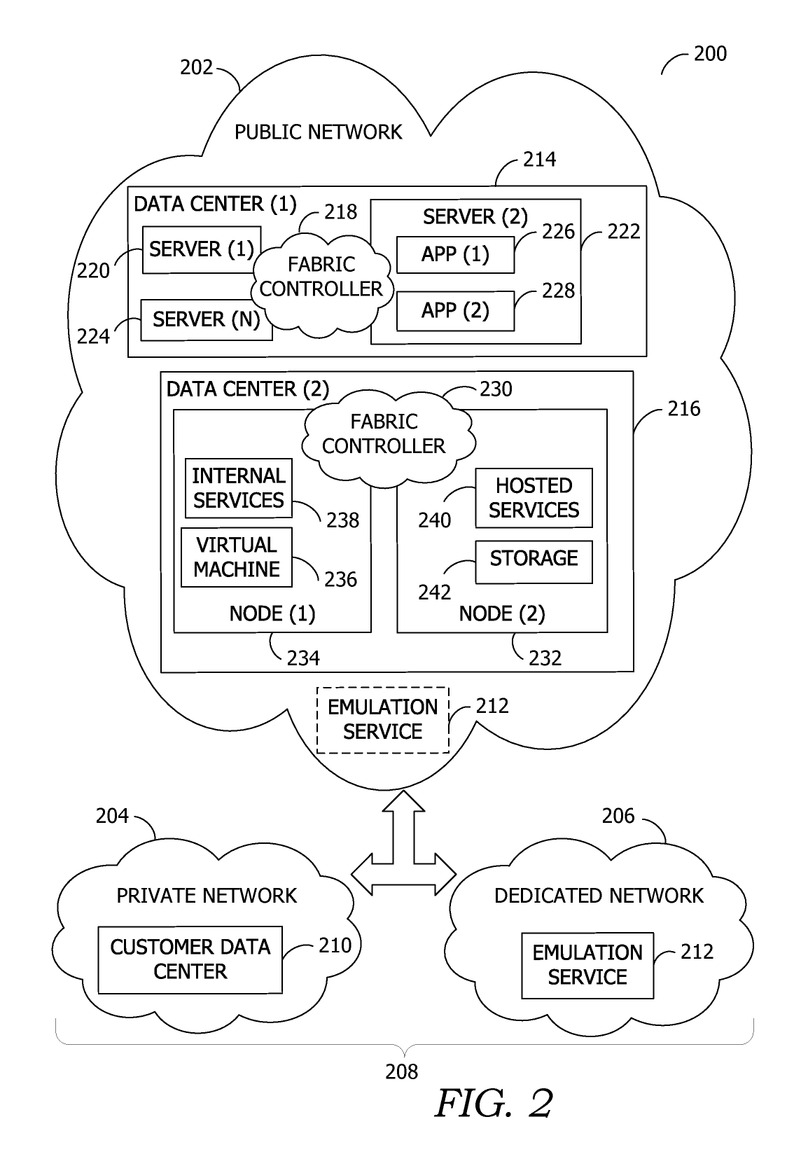

The disclosed examples may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The discloses examples may be practiced in a variety of system configurations, including personal computers, laptops, smart phones, mobile tablets, hand-held devices, consumer electronics, specialty computing devices, etc. The disclosed examples may also be practiced in distributed computing environments, such as those disclosed in FIG. 2 described in more detail below, where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, a power supply 122, and a network component 124. Computer device 100 should not be interpreted as having any dependency or requirement related to any single component or combination of components illustrated therein. While computer device 100 is depicted as a seemingly single device, multiple computing devices 100 may work together and share the depicted device resources. For instance, memory 112 may be distributed across multiple devices, processor(s) 114 may provide housed on different devices, and so on.

Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. Such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and the references herein to a “computing device.”

Memory 112 may include any of the of the computer-readable media discussed below in the section captioned “Exemplary Operating Environment.” Memory 112 may be used to store and access instructions configured to carry out the various operations disclosed herein. In some examples, memory 112 includes computer-storage media in the form of volatile and/or nonvolatile memory, removable or nonremovable memory, data disks in virtual environments, or a combination thereof.

Processor(s) 114 may include any quantity of processing units that read data from various entities, such as memory 112 or I/O components 120. Specifically, processor(S) 114 are programmed to execute computer-executable instructions for implementing aspects of the disclosure. The instructions may be performed by the processor, by multiple processors within the computing device 100, or by a processor external to the client computing device 100. In some examples, the processor 114 are programmed to execute instructions such as those illustrated in the flowcharts discussed below and depicted in the accompanying drawings. Moreover, in some examples, the processor(s) 114 represent an implementation of analog techniques to perform the operations described herein. For example, the operations may be performed by an analog client computing device 100 and/or a digital client computing device 100.

Presentation component(s) 116 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 100, across a wired connection, or in other ways.

Ports 118 allow computing device 100 to be logically coupled to other devices including I/O components 120, some of which may be built in. Examples I/O components 120 include, for example but without limitation, a microphone, joystick, game pad, satellite dish, scanner, printer, wireless device, etc.

In some examples, the network component 124 includes a network interface card and/or computer-executable instructions (e.g., a driver) for operating the network interface card. Communication between the computing device 100 and other devices may occur using any protocol or mechanism over any wired or wireless connection. In some examples, the network component 124 is operable to communicate data over public, private, or hybrid (public and private) using a transfer protocol, between devices wirelessly using short range communication technologies (e.g., near-field communication (NFC), BLUETOOTH branded communications, or the like), or a combination thereof.

Turning now to FIG. 2, an exemplary block diagram illustrates a cloud-computing environment for monitoring the health of an application during an upgrade. Architecture 200 illustrates an exemplary cloud-computing infrastructure, suitable for use in implementing aspects of the disclosure. Architecture 200 should not be interpreted as having any dependency or requirement related to any single component or combination of components illustrated therein. In addition, any number of nodes, virtual machines, data centers, role instances, or combinations thereof may be employed to achieve the desired functionality within the scope of embodiments of the present disclosure.

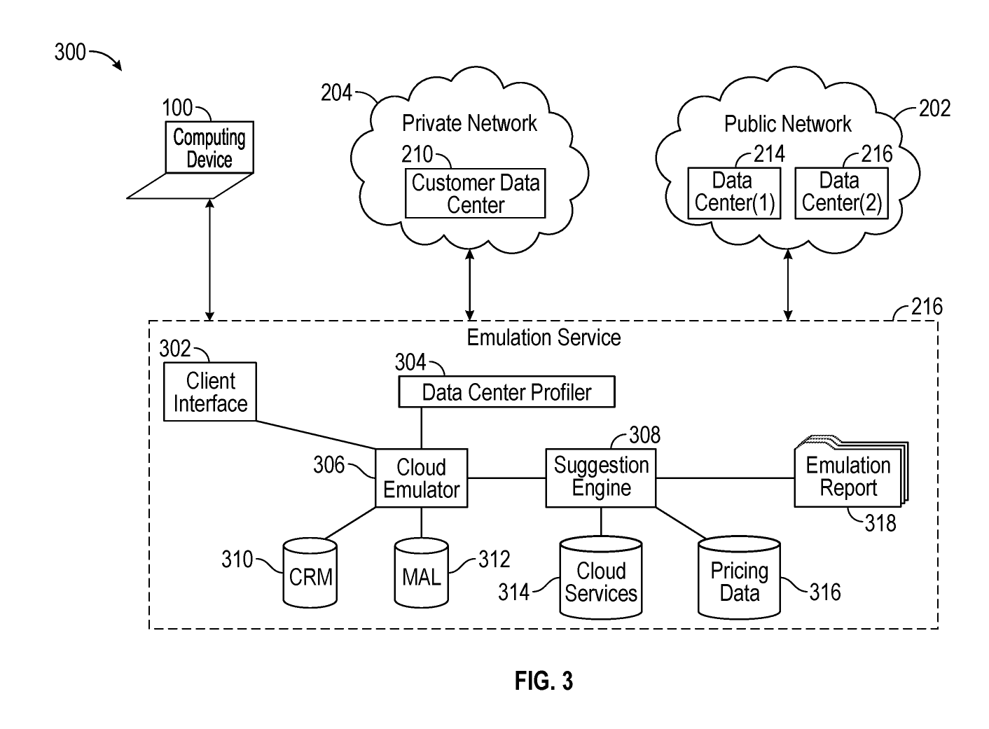

The distributed computing environment of FIG. 2 includes a public network 202, a private network 204, and a dedicated network 206. Public network 202 may be a public cloud-based network of computing resources, for example. Private network 204 may be a private enterprise network or private cloud-based network of computing resources. And dedicated network 206 may be a third party network or dedicated cloud-based network of computing resources. In some examples, private network 204 may host a customer data center 210, and dedicated network 206 may host cloud emulation services 212, which are discussed in more detail below relative to FIG. 3.

Hybrid cloud 208 may include any combination of public network 202, private network 204, and dedicated network 206. For example, dedicated network 206 may be optional, with hybrid cloud 208 comprised of public network 202 and private network 204. Along these lines, some customers may opt to only host a portion of their customer data center 210 in the public network 202 and/or dedicated network 206, retaining some of the customers' data or hosting of customer services in the private network 204. For example, a customer that manages healthcare data or stock brokerage accounts may elect or be required to maintain various controls over the dissemination of healthcare or account data stored in its data center or the applications processing such data (e.g., software for reading radiology scans, trading stocks, etc.). Myriad other scenarios exist whereby customers may want to need to keep certain portions of its data centers under the customers' management. Thus, in some examples, customer data centers may use a hybrid cloud 208 in which some data storage and processing is performed in the public network 202 while other data storage and processing is performed in the dedicated network 206.

Public network 202 may include data centers configured to host and support operations, including tasks of a distributed application, according to the fabric controller 218. It will be understood and appreciated that data center 214 and data center 216 shown in FIG. 2 are merely examples of suitable implementations for accommodating one or more distributed applications, and are not intended to suggest any limitation as to the scope of use or functionality of examples disclosed herein. Neither should data center 214 and data center 216 be interpreted as having any dependency or requirement related to any single resource, combination of resources, combination of servers (e.g., servers 220 and 224) combination of nodes (e.g., nodes 232 and 234), or set of APIs to access the resources, servers, and/or nodes.

Data center 214 illustrates a data center comprising a plurality of servers, such as servers 220 and 224. A fabric controller 218 is responsible for automatically managing the servers 220 and 224 and distributing tasks and other resources within the data center 214. By way of example, the fabric controller 218 may rely on a service model (e.g., designed by a customer that owns the distributed application) to provide guidance on how, where, and when to configure server 222 and how, where, and when to place application 226 and application 228 thereon. One or more role instances of a distributed application, may be placed on one or more of the servers 220 and 224 of data center 214, where the one or more role instances may represent the portions of software, component programs, or instances of roles that participate in the distributed application. In other examples, one or more of the role instances may represent stored data that are accessible to the distributed application.

Data center 216 illustrates a data center comprising a plurality of nodes, such as node 232 and node 234. One or more virtual machines may run on nodes of data center 216, such as virtual machine 236 of node 234 for example. Although FIG. 2 depicts a single virtual node on a single node of data center 216, any number of virtual nodes may be implemented on any number of nodes of the data center in accordance with illustrative embodiments of the disclosure. Generally, virtual machine 236 is allocated to role instances of a distributed application, or service application, based on demands (e.g., amount of processing load) placed on the distributed application. As used herein, the phrase “virtual machine” is not meant to be limiting, and may refer to any software, application, operating system, or program that is executed by a processing unit to underlie the functionality of the role instances allocated thereto. Further, the virtual machine(s) 236 may include processing capacity, storage locations, and other assets within the data center 216 to properly support the allocated role instances.

In operation, the virtual machines are dynamically assigned resources on a first node and second node of the data center, and endpoints (e.g., the role instances) are dynamically placed on the virtual machines to satisfy the current processing load. In one instance, a fabric controller 230 is responsible for automatically managing the virtual machines running on the nodes of data center 216 and for placing the role instances and other resources (e.g., software components) within the data center 216. By way of example, the fabric controller 230 may rely on a service model (e.g., designed by a customer that owns the service application) to provide guidance on how, where, and when to configure the virtual machines, such as virtual machine 236, and how, where, and when to place the role instances thereon.

As discussed above, the virtual machines may be dynamically established and configured within one or more nodes of a data center. As illustrated herein, node 232 and node 234 may be any form of computing devices, such as, for example, a personal computer, a desktop computer, a laptop computer, a mobile device, a consumer electronic device, a server, the computing device 100 of FIG. 1, and the like. In one instance, the nodes 232 and 234 host and support the operations of the virtual machine(s) 236, while simultaneously hosting other virtual machines carved out for supporting other tenants of the data center 216, such as internal services 238 and hosted services 240. Often, the role instances may include endpoints of distinct service applications owned by different customers.

Typically, each of the nodes include, or is linked to, some form of a computing unit (e.g., central processing unit, microprocessor, etc.) to support operations of the component(s) running thereon. As utilized herein, the phrase “computing unit” generally refers to a dedicated computing device with processing power and storage memory, which supports operating software that underlies the execution of software, applications, and computer programs thereon. In one instance, the computing unit is configured with tangible hardware elements, or machines, that are integral, or operably coupled, to the nodes to enable each device to perform a variety of processes and operations. In another instance, the computing unit may encompass a processor (not shown) coupled to the computer-readable medium (e.g., computer storage media and communication media) accommodated by each of the nodes.

The role instances that reside on the nodes support operation of service applications, and may be interconnected via application programming interfaces (APIs). In one instance, one or more of these interconnections may be established via a network cloud, such as public network 202. The network cloud serves to interconnect resources, such as the role instances, which may be distributed across various physical hosts, such as nodes 232 and 234. In addition, the network cloud facilitates communication over channels connecting the role instances of the service applications running in the data center 216. By way of example, the network cloud may include, without limitation, one or more communication networks, such as local area networks (LANs) and/or wide area networks (WANs). Such communication networks are commonplace in offices, enterprise-wide computer networks, intranets, and the Internet, and therefore need not be discussed at length herein.

FIG. 3 is a block diagram of a networking environment 300 for profiling and emulating customer data centers in a cloud computing environment. Networking environment 300 involves a computing device 100, a private network 204 with the customer data center 210, a public network 202 with the cloud computing environment (shown as data centers 214 and 216), and an emulation service 216 being run on an application server (not shown for clarity). The illustrated devices and services are provided merely for explanatory purposes and are not meant to limit all examples to any particular set or type of devices and services.

The computing device 100, private network 204, public network 202, and emulation service 216 communicate over a data-transfer network, for example the Internet, a local area network (LAN), a wide area network (WAN), point-to-point connection, or the like. Such data-transfer networks are well known and therefore need not be discussed at length herein.

The emulation service 216 represents computer-executable instructions executable by processing units of one or more application servers to profile the customer data center 210 and emulate the profiled customer data center 210 in the data centers 214-216 of the cloud computing environment. In some examples, the emulation service 216 specifically includes a client interface 302, a data center profile 304, a cloud emulator 306, a suggestion engine 308, a customer relationship management (CRM) repository 310, a managed account list (MAL) repository 312, a cloud services repository 314, a pricing data repository 316, and emulation reports 218. These instructions, once programmed into executable form and stored in computer or virtual memory, turn the hosting application server of the emulation service into a profiling-and-emulating-focused computing device capable of carrying out the profiling, emulation, and emulation-report generation techniques disclosed herein.

The computing device 100 provides a user interface (UI) to a user (e.g., customer or cloud representative) that enables the user to start profiling and emulation of the customer data center 210. In the UI, the user may specify relevant enterprise and data center (DC) parameters. Examples of the type of information collected during this phase include, without limitation: the particular industry in which the enterprise operates (e.g., healthcare, financial services, information technology, etc.); a quantity of computer programmers needing access to the customer data center 210; a quantity of licenses to particular software; server operating system; web page views; number of unique website hosted; file transfer information (e.g., inbound or outbound data transfers); redundancy; current SaaS, PaaS, or IaaS services; operating regions; workloads; quantity of enterprise web sites; quantity or type of data storage; amount of on-premises and/or off-premises data storage; build minutes; load testing minutes; IT support package; size of or instances of virtual machines (VMs); number of servers; daily bandwidth requirements; amount of outgoing bandwidth generated by web pages; service tiers required by business; number of web sockets; number or the like.

Additionally, to aid the accuracy of the profiling performed on the customer data center, some of the enterprise and DC parameters may be gathered through questioning in the UI that asks the user to indicate parameters in relation to other comparable businesses of the customer. In this vein, the user may be asked through the UI to indicate specifics about the customer data center relative to other data centers in the industry or in general. For example, the user may be asked any of whether the customer data center 210 is larger or smaller than comparable businesses, whether data in the customer data center are updated more or less frequently than comparable businesses, whether the customer has more or fewer software developers than comparable businesses, whether the customer data center manages more or fewer web sites than comparable businesses, whether the customer has more or fewer needs for productivity software than comparable businesses, whether the customer has more or fewer needs for information technology (IT) support than comparable business, whether data backup is more or less important to the customer than comparable businesses, whether the customer data center stores more or less data than comparable businesses, or the like. Answers to these questions may be entered, in some examples, in the UI of the computing device 100 and subsequently transmitted to the emulation service 216.

The client interface 302 interacts with the computing device 100 by providing server-side interactions with the previously discussed client UIs. In some examples, the client interface 302 receives the enterprise and DC parameters entered by the customer representative or cloud representative at the computing device 100. For example, requests to profile the customer data center 210, or a portion thereof, may be received along with indications of the type of industry, number of software programmers, types of software licenses, current backup procedures, or various other metrics of the customer data center 210 (either specifically or relative to other comparable businesses). In some examples, the received enterprise and DC parameters received by the client interface 302 are provided to the cloud emulator 306. The cloud emulator 306 may then engage the data center profiler 304 to systematically profile the customer data center 210, either independent or dependent on the received enterprise and DC parameters from the representative.

To profile the customer data center, in some examples, the data center profiler 304 accesses the customer data center 210 through a uniform resource locator, API, or other link or remote instruction, or directly through a wired or wireless (e.g., BLUETOOTH® brand connection) connection. Once the customer data center 210 is accessed, the data center profiler 304 scopes the customer data center 210 to obtain the hardware (e.g., servers or VMs) and software being used, the software licenses used, the type and amount of storage available, and the real-time workload metrics of the customer data center 210. For more concrete examples, without limitation, the hardware may indicate a particular number of servers or processors (either physical or virtually); the software may indicate specific operating systems or applications; and the storage may be indicated in quantities of different types, such as BLOB, table, queue, file, or the like.

The real-time workload metrics indicate, in some examples, the real-time processing speeds (e.g., computation cycles, processor(s) speeds, etc.) and quantities of the various storage that are used. As previously discussed, alternative examples scope the customer data center 210 for a period of time or during a particular event and either: (1) identify magnitudes and times of upper and lower limits of experienced processing and the storage usage, (2) average the processing and storage usage over the period of time or during the event, or (3) perform a combination thereof (e.g., average while noting times of extreme high and low processing and storage usage).

In operation, the data center profiler 304 generates a summary of the information uncovered through scoping the customer data center 210, specifically indicating the hardware and software being used and the real-time processing and memory usage. In some examples, the data center profiler 304 creates a “data center (DC) profile” of the customer data center 210. In various examples, the DC profile may indicate the identified combination of the identified hardware, software, software licenses, type and amount of storage, and real-time workload metrics of the customer data center 210.

To this end, in some examples, the DC profile indicates the real-time processing computation cycles of the customer data center 210; the real-time BLOB, table, queue, and file storage; the number of software licenses currently being used; the type of software (e.g., operating system, application, etc.); size of data being stored (either cumulatively or across the different types of data storage); input/output transaction time to memory (e.g., speed of accessing the various stored data); availability of memory (e.g., downtime statistics); or a combination thereof. Additionally or alternatively, the DC profile may also retrieve customer service request and solution information (e.g., number of customer service requests, time for resolving such requests, types of requests, and the like); data redundancy and backup information; number of programmers or administrative users having access to the customer data center 210; number of working users needing access to the applications; number of users visiting web pages and online applications; or a combination thereof. Additionally or alternatively, the DC profile may also include the general parameters specified by the representative in comparison to other businesses. These lists of the various parameters that may be included in the DC profile are not exhaustive. Other parameters specific to the processing, storage, and management of the customer data center 210 may also be included.

The DC profile may be modified or supplemented with any of the previously mentioned information provided about the customer data center 210 by the customer or cloud representative. For instance, the industry specified by the representative may be added to the DC profile. Answers to how the customer data center 210 or the customer compare to other comparable businesses may also or alternatively be added to the DC profile. For example, if the representative indicates that the customer data center 210 requires more storage or IT storage than comparable businesses, parameters in the DC profile may be adjusted by a percentage (e.g., 1%, 5%, 10%, etc.) or factor (e.g., twice, thrice, etc.).

Allowing the user to specify actual and general parameters enables the customer data center 210 to be profiled more accurately for emulation because assumptions may be developed on the customer data center 210 that may not be evident based on the user-provided enterprise and DC parameters, or through profiling the hardware and software of the customer data center 210 alone. For instance, knowing the industry, quantity of computer programmers, and quantity of devices or VMs of the customer data center 210 allows the emulation service 216 to access similarly profiled data centers being hosted in the cloud computing environment, leading to more accurate predictions of the computational needs of the customer data center 210. For example, a customer data center 210 in the healthcare industry may be compared against other healthcare-industry data centers in the cloud computing environment. A customer data center 210 with particular data redundancy needs may need to be compared against similar data centers in the cloud computing environment that have such redundancy specifications, either in the same or different industries. Myriad other circumstances may also be considered during the profiling and emulation modeling discussed herein.

Many cloud computing companies have access to repositories of customer information from sales of other non-cloud products. These repositories may provide a wealth of information about the company that may be useful during profiling and emulation. The CRM repository 310 provides customer relationship information typically included in a CRM database, and the MAL repository 312 includes managed-account information typically stored in a database. While these repositories may include a plethora of data, at least some examples include, without limitation, customer names, software license quantities, device specifics, contact information, account information, customer profile information, sales information, type of industry, known competitors, or the like. This information may be included in the DC profile supplied to the cloud emulator 306. For example, the data center profiler 304 may not be able to ascertain the number particular software licenses that the customer has purchased for software that is provided by the cloud computing company. The CRM repository 310 may have this information and provide it to the cloud emulator 306 to build a more complete profile picture of the customer data center 210. In another example, the MAL repository 312 may store information about e-mail accounts of the customer that are provided by the cloud computing company, including the number of e-mail addresses, amount of e-mail traffic, and the like. This managed-account information may be provided to the cloud emulator 306. If the cloud computing company has access to various customer information in managed repositories, the customer information may be accessed and used in emulating of the customer data center 210.

The DC profile is provided, in some examples, to the cloud emulator 306 for use in emulating the same hardware, software, and workload parameters in the data centers 214 and 216 of the cloud computing environment. In some examples, the cloud emulator 306 emulates the DC profile by providing all or a combination of the enterprise and data center parameters to the cloud computing environment for emulation. The customer data center 210—or a selected portion thereof—may be emulated on the data centers 214 and 216, either directly or indirectly through dedicated emulation software. In some examples, emulation of the customer data center 210 produces an “emulated workload” that indicates the emulated processing and storage metrics of the customer data center 210 operating in the cloud computing environment. The emulated workload may include any of the previously discussed enterprise and DC parameters (e.g., industry, computer programmers, relative storage indications, etc.); profiled hardware, software, software license, and real-time workload usage (e.g., computation cycles, BLOB usage, etc.); customer information; and/or managed account information.

In some examples, the cloud emulator 306 receives the emulated workload from the cloud computing environment (or dedicated emulation software) and communicates the emulated workload to the suggestion engine 308. The suggestion engine 308 may access the cloud services repository 314, which includes a list of available cloud services of the cloud computing environment, and select appropriate cloud services to recommend in an emulation report 318 to the customer representative based on the emulated workload. In other words, the processing and storage metrics determined through emulation may be used by the suggestion engine 308 to automatically select cloud services for the emulation report 318 that are needed (or otherwise appropriate) appropriate for operating the customer data center 210 in the cloud computing environment.

Additionally or alternatively, the cloud computing environment may suggest cloud services used by other data centers hosted for customers in the same industry, with similar numbers of software programmers, having similar quantities of web traffic or software licenses, or otherwise comparable to the customer. Moreover, in some examples, these comparison metrics may be adjusted based on the customer or cloud representatives answers to questions comparing the customer to other companies. For example, if the representative indicates that the customer data center requires more storage that comparable businesses, the data centers 214 and 216 may be mined for data centers of the customers that are in the same industry, identify the current or historical storage usage of the comparable customer, and adjust that storage usage by a predetermined factor (e.g., 2%, 5%, 10%, 20%, or the like; multiple of two, three, four, or the like; 1 TB, 2 TB, STB, or the like; etc.) to accommodate the representative's request.

Once cloud services are identified, some examples also provide cost information for the cloud services in the emulation report 318. The cost information may be based on pricing data in the pricing data repository 316. Pricing information is optional and may not be included in all examples.

The generated emulation report 318 is provided back to the representative through the client interface 302. The emulation report 318 may also be saved by the emulation service 206 so that a user may access it at any time. Users may emulate multiple different portions of the customer data center 210 and save the resultant emulation reports 318 for each.

Having emulation reports 318 that provide a list services (and possibly pricing for those services) for handling the migration and operation of the customer data center drastically streamline discussions between the customer representative and the cloud representative. Additionally, most cloud computing migrations must be approved by higher-up managers of a company, who may or may not completely understand the value and resources needed to operate the customer data center 210 in the cloud computing environment. The emulation report 218 detailing that the cloud computing environment has the resources to operate the customer data center 210 in its current form, what those resources are, and the cost of those resources makes management's decision much easier.

Allowing the user to specify actual and general parameters enables customer data center to better profiled for emulation because assumptions may be developed on the customer data center 210 that may not be evident based on the user-provided enterprise and DC parameters or through profiling the hardware and software of the customer data center 210 alone. For instance, as discussed in more detail below, knowing the industry, quantity of computer programmers, and quantity of devices or VMs of the customer data center 210 allows the emulation service 216 to access similarly profiled data centers being hosted in the cloud computing environment, leading to more accurate predictions of the computational needs of the customer data center 210. For example, a customer data center 210 in the healthcare industry may be compared against other healthcare-industry data centers in the cloud computing environment. A customer data center 210 with particular data redundancy needs may need to be compared against similar data centers in the cloud computing environment that have such redundancy specifications, either in the same or different industries. Myriad other circumstances may also be considered during the profiling and emulation modeling discussed herein.

In some examples, the emulation reports 318 are stored for the representative and may be edited by the representative to specify new parameters for emulation. For example, the representative may increase the real-time detected storage and computation cycles to see what cloud services are needed if the customer data center 210 grows in size. Some examples allow the user to resubmit the emulation reports 318 back to the emulation service 206 to run additional emulations based on the modified parameters. This allows the customer's data center to not have to constantly be probed for every emulation while still providing a very accurate technique for deciphering cloud resource needs, because the real-time processing and storage metrics of the customer data center 210 may be used to provide the initial baseline suggestion of cloud services, and the representative may see emulation results for different technical scenarios.

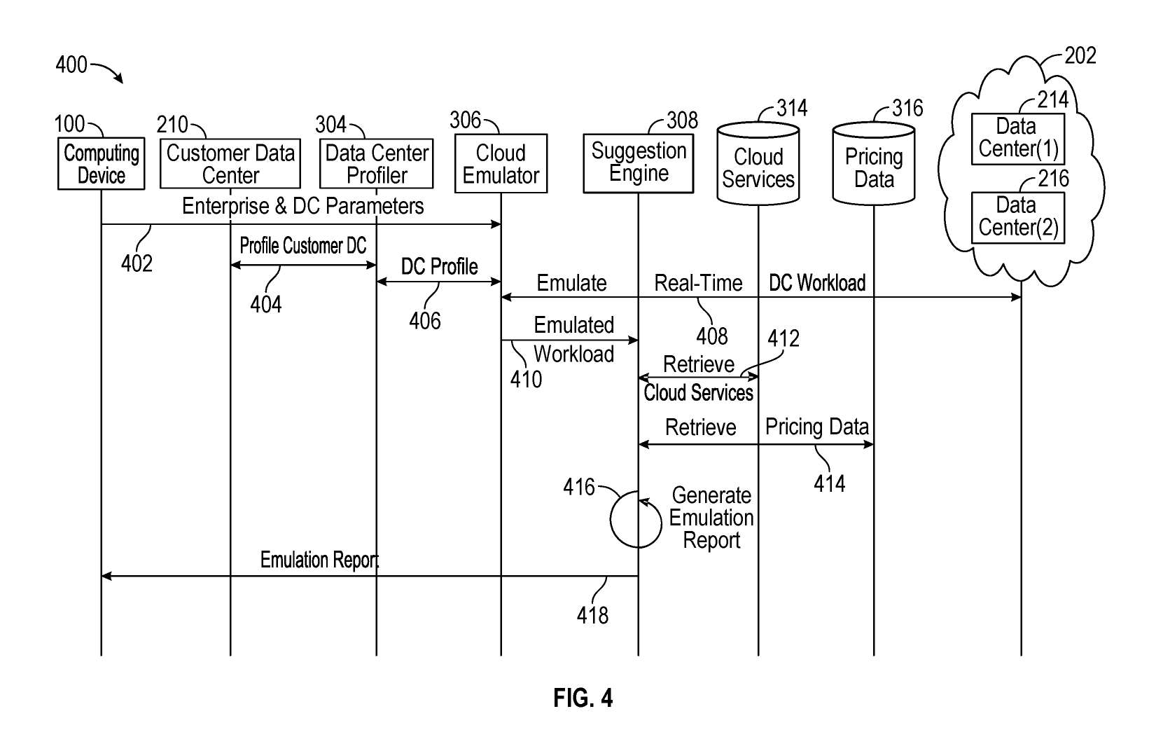

FIG. 4 is a sequence diagram of a networking environment 400 for profiling and emulating customer data centers 210 in a cloud computing environment. Networking environment 400 illustrates various interactions between the previously discussed devices and executable instructions. It should be noted that networking environment 400 and its illustrated sequences represent only one example implementation of the profiling and emulation techniques discussed herein. Difference sequence operations may be performed by alternative examples without departing from the scope of this disclosure.

Networking environment 400 involves a computing device 100 of a user, the customer data center 210, the data profiler 304, the cloud emulator 306, the suggestion engine 308, the cloud services repository 314, the pricing data repository 316, and the data centers 214 and 216 of the cloud computing environment in the public network 202. As shown at sequence 402, a user electing to run a data center emulation provides enterprise and DC parameters regarding the customer data center 210 and its respective enterprise to the cloud emulator 306. As shown at sequence 404, the cloud emulator 306 triggers the data center profiler 304 to profile the customer data center 210 and obtain the DC profile information mentioned above. The DC profile may include the identified hardware, software, software licenses, type and amount of storage, and real-time workload metrics of the customer data center 210 obtained through profiling.

The DC profile is shared with the cloud emulator 306, as shown at sequence 406. The cloud emulator 306 emulates the real-time DC workload data in the DC profile data, either directly on the data centers 214 and 216 of the cloud computing environment or indirectly through emulation software that mirrors the data centers 214 and 216, as shown at sequence 408. As shown at sequence 410, an emulated workload is produced from this emulation that indicates the emulated processing and storage metrics of the customer data center 210 operating in the cloud computing environment.

The emulated workload is provided to the suggestion engine 308, which in turn identifies cloud services in the cloud services repository 314 needed to operate the customer data center 210 in the cloud computing environment. Optionally, pricing information for the identified cloud services may be accessed and used to generate cost estimates for the user. As shown at sequence 416, the suggestion engine 308 generates an emulation report that details the identified cloud services that were selected based on the real-time-metric emulation and (optionally) the costs associated with those cloud services.

As shown at sequence 418, the emulation report is provided back to the user, providing an easy-to-understand and automatically generated summary of what services would be needed for operating the customer data center 210 in the cloud computing environment. In some examples, the emulation report is interactive and allows for the user to modify the various workload metrics profiled from the customer data center 210 and used during in emulation and resubmit additional emulation requests that produce additional emulation reports covering various data center scenarios.

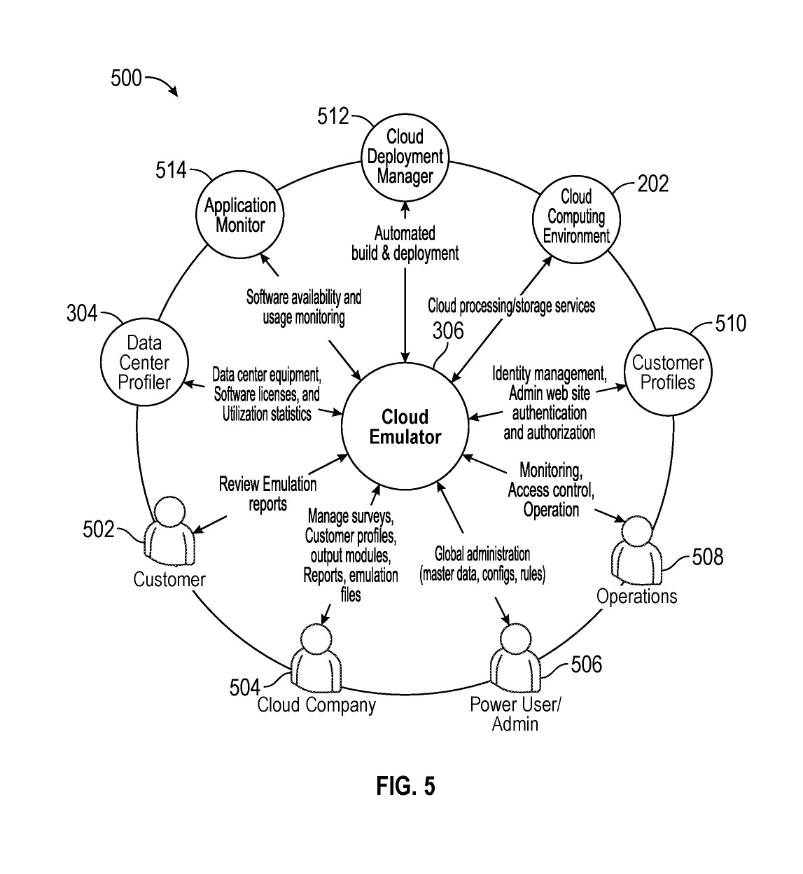

FIG. 5 is a relationship diagram 500 of the various services, devices, and people interacting with the cloud emulator 306. The relationship diagram 500 shows four different users interacting with the cloud emulator 306: a customer representative 502, a cloud company representative 504, a power/administrative user 506, and an operations user 508. Additionally, the cloud emulator 306 interacts with the data center profiler 304, an application monitor 514, a cloud deployment manager 512, the cloud computing environment 202, and various customer profiles 510. The depicted relationships are provided to illustrate points for some—not all—examples. Alternative services, devices, and people may be incorporated in alternative examples.

The customer representative 502 may request emulation of the customer data center 210, submit enterprise and DC parameters, and review emulation reports for the customer data center 210. IN some examples, the emulation reports may be modified and resubmitted by the customer representative 502 for additional emulation of the customer data center 210 under various other enterprise and DC parameters.

Similarly, the cloud company representative 504 may also submit emulation requests, enterprise and DC parameters, and modify emulation reports for follow-up emulations. Additionally or alternatively, the cloud company representative 504 may also manage customer feedback surveys about the cloud sales experience, create or modify customer profiles, generate output modules to tailor the emulation reports to the particular customer (e.g., customer logo, pricing information, storage information, etc.), and otherwise manipulate or access the various emulation files associated with the emulation reports.

The power/administrative user 506 sets and manages global administration access and data. Examples of such administration data include, without limitation, global data, configurations, and logic for emulating the data centers in the cloud computing environment 202.

The operations user 508 monitors the cloud emulator 306 to ensure it is operational. The operations user 508 may also control user access to the cloud emulator 306. For example, the customer representative 502 may need to first be approved by the operations user 508 before gaining emulation may be requested.

Turning to the operational side of the relationship diagram 500, the data center profiler 304 is configured, in some examples, to access and the scope the customer data center 210. The data center profiler 304 may provide the uncovered data center equipment, software licenses, and real-time utilization statistics (e.g., how much processing and storage capacity is currently being used). Any other previously discussed DC profile parameters may also or alternatively be gathered by the data center profiler

The application monitor 514 represents executable instructions for monitoring the availability and usage of software applications in the customer data center 210. For example, if the customer data center 210 has 100 licenses to use a particular software program, the application monitor 514 may monitor the availability and usage of that program in the customer data center 210 to understand whether 100 licenses are really needed, more licenses are needed, or the like. Often, companies purchase far too few or far too many software licenses than are needed. The application monitor 514 may provide software availability and usage statistics as part of the DC profile to the cloud emulator 306, so that the cloud emulator 306 may emulate exactly what is being used in real time by the customer data center 210.

The cloud deployment manager 512 represents executable instructions for automatically building and deploying the real-time DC workloads, including any of the DC profile parameters discussed herein, for emulation on the cloud computing environment 202—either directly or through a mirrored version of the cloud computing environment 202. In some examples, the cloud deployment manager 512 builds the real-time DC workloads for emulation automatically upon receipt of the DC profile generated by the data center profiler 304. Moreover, the built real-time DC workloads may include any of the customer profiles 510 in the CRM repository 310 or the MAL repository 312.

The cloud emulator 306 interacts with the illustrated devices, services, and people shown in relationship diagram 500 to profile the customer data center 210, emulate the profiled real-time DC parameters of the customer data center 210 in the cloud computing environment, and generate emulation reports that may easily be shared with the customer representative 502. Basing the emulation customer data center 210 on the real-time DC parameters ensures that the customer 210 is presented with just the cloud services he or she needs to operate the customer data center 210 in the cloud computing environment.

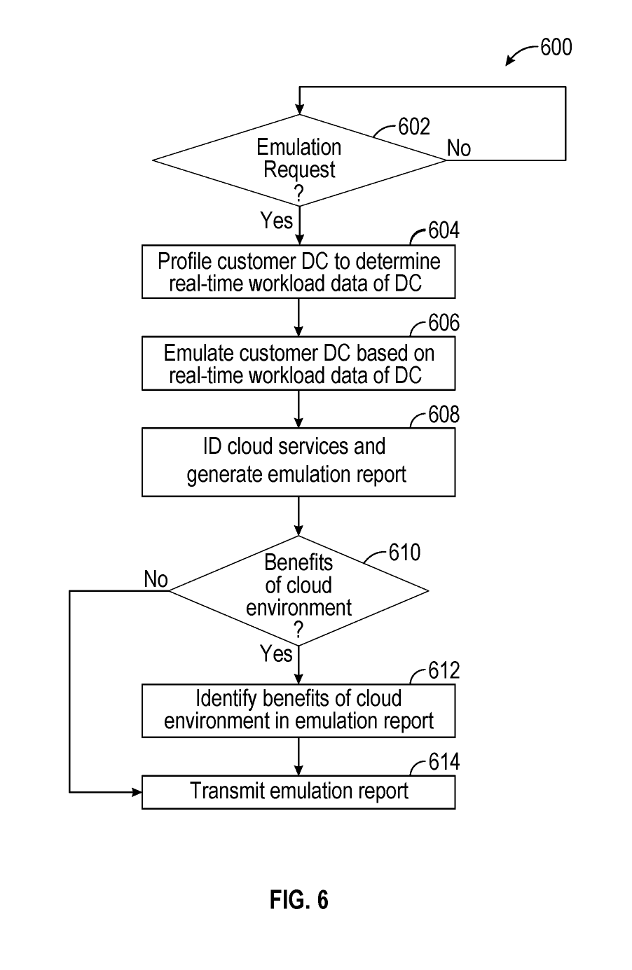

FIG. 6 is a flowchart diagram illustrating a work flow 600 for emulating and profiling the customer data center 210. The illustrated steps may be performed in different sequences other than that shown in work flow 600. Work flow 600 waits until an emulation request is received by the emulation service 216, as shown at decision box 602. Once one is received, the customer data center 210 is identified and profiled to determine real-time workload data, as shown at 604. Additionally, DC profile data may be received from the user requesting the emulation. The real-time workload data of the customer data center 210 and the additional user-specified DC profile data (if any) are used to emulate the customer data center 210 in a cloud computing environment, as shown at 606.

A suggestion engine 208 identifies cloud services to the suggest to the user based on the emulation of the customer data center 210, and an emulation report 318 indicating the identified cloud services is generated, as shown at 608. The emulation report indicates the cloud services 314 and potential costs associated therewith.

In some examples, the emulation service 216 understands the real-time workload and DC profile parameters. So the suggestion engine 308 may be configured to identify benefits of cloud services 314 being suggested to the user compared to the current hardware, software, and infrastructure of the customer data center 210, as shown at 610. For example, if the cloud services 314 offer faster processing times, better redundancy metrics, cheaper costs per computation cycle, or some other relevant parameter over the customer data center 210, these benefits (which may be automatically identified by the suggestion engine 308) are identified in the emulation report 318, as shown at 612. If no benefits are found or if the suggestion engine 308 is configured to identify benefits in the emulation report 318, the emulation report 318 is transmitted to the requesting user, as shown at 614.

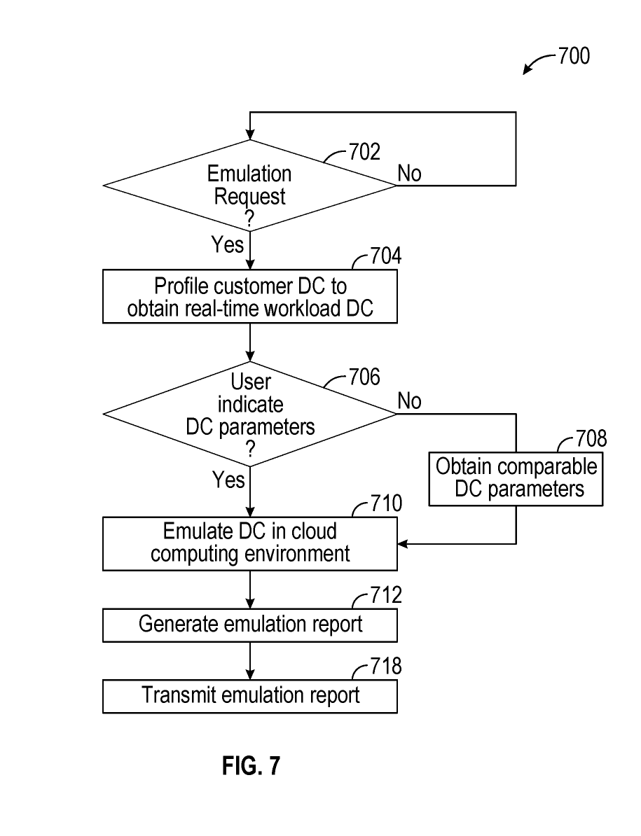

FIG. 7 is a flowchart diagram illustrating a work flow 700 for emulating and profiling the customer data center 210. The illustrated steps may be performed in different sequences other than that shown in work flow 700. Work flow 700 waits until an emulation request is received by the emulation service 216, as shown at decision box 702. Once one is received, the customer data center 210 is identified and profiled to determine real-time workload data, as shown at 704.

Additionally, DC profile data may be received from the user requesting the emulation that general specify parameters in comparison to comparable businesses (e.g., whether the customer data center 210 is larger than the data centers of comparable businesses, operates in the same geographic regions of comparable businesses, requires additional storage or bandwidth than comparable businesses, or the like), as shown at decision box 706. To quantify these general DC profile parameters, some examples access the data centers of comparable businesses currently or historically hosted by the cloud computing environment. Any of the real-time workload and DC profile parameters discussed herein for the data center of the comparable business may then be obtained, as shown at 708. For example, if the customer data center 210 is operating in India and is focused on the healthcare industry, another healthcare industry data center operating in India may be accessed and the computation cycles, storage parameters, or customer service needs may be gathered therefrom.

The customer data center 210 is emulated in the cloud computing environment using the real-time workload data, either alone or in conjunction with the comparable-business DC profile data, as shown at 710. As shown at 712, an emulation report is generated by the suggestion engine 308, indicating the cloud services necessary or recommended for operating the customer data center 210 in the cloud computing environment. The emulation report 318 may be transmitted to the user, as shown at 718.

### Additional Examples

Some examples are directed to computer storage media having computer-executable instructions embodied thereon that, when executed, perform steps for emulating a customer data center in a cloud computing environment and determining cloud resources for operating the customer data center in the cloud computing environment. A data center profiler is configured for profiling at least a portion of the customer data center to determine real-time workload data of the customer data center that indicates a quantity of computation cycles associated with current operation of the portion of the customer data center. A cloud emulator is configured for emulating the customer data center in the cloud computing environment based on the real-time workload data of the customer data center. A suggestion engine is configured for identifying the cloud resources for operating the customer data center in the cloud computing environment based on said emulation of the customer data, and generating an emulation report that indicates the identified cloud resources for operating the customer data center in the cloud computing environment. A network component transmits the emulation report over a network to a user, and the emulation report describes features of operating the customer data center in the cloud computing environment to the user via a user interface.

Some examples are directed to emulating a customer data center in a cloud computing environment. A request to emulate the customer data center in the cloud computing environment is received. The customer data center is profiled to obtain real-time workload data of the customer data center, and the profiling includes determining required processing and storage requirements needed by the customer data center based on the real-time workload data of the customer data center. The customer data center is emulated in the cloud computing environment based on the processing and storage requirements to obtain emulated cloud workload data for operating the customer data center in the cloud computing environment, and the emulated workload data includes at least one cloud service for operating the customer data center. An emulation report is generated indicating the at least one cloud service, and the emulation report is communicated over a network to inform a user of one or more requirements for operating the customer data center in the cloud computing environment.

Some examples are directed to an emulation and suggestion system for emulating a customer data center in a cloud computing environment and suggesting at least one cloud resource for operating the customer data center in the cloud computing environment. The emulation and suggestion system include memory for storing data center parameters identifying the customer data center and one more processors. The processors are programmed to: profile at least a portion of the customer data center to determine real-time workload data of the customer data center, emulate the customer data center in the cloud computing environment based on the real-time workload data of the customer data center, identify the cloud resources for operating the customer data center in the cloud computing environment based on said emulation of the customer data center, generate an emulation report that indicates the identified cloud resources of the cloud computing environment for operating the customer center, and transmit the emulation report over a network so that a user can identify the cloud resources for operating the customer data center in the cloud computing environment.

Alternatively or in addition to the other examples described herein, some examples include any combination of the following:
a user interface configured for receiving enterprise parameters indicating at least one member of a group comprising: an industry associated with the customer data center, a number of customer data center users, one or more service tiers associated with the customer data center, or a number of software licenses associated with the customer data center, and wherein the cloud resources for operating the customer data center are selected, at least in part, based on the received enterprise parameters;
wherein the identified cloud computing resources include at least one member of a group comprising: data redundancy metrics, block binary large object (BLOB) storage; page BLOB storage, table storage, queue storage, or data import information, or data export information associated with the customer data center;
wherein the determined real-time data of the customer data center comprise an indication of a quantity or type of data storage associated with the customer data center; wherein the determined real-time workload data of the customer data center comprise a number of computing devices of the customer data center identified during said profiling, and wherein the emulation service is further configured for: analyzing the number of computing devices of the customer data center and the computation cycles of the customer data center to determine an overall machine utilization of the customer data center;
wherein the determined real-time workload data of the customer data center comprise a number of computing devices and a number of software licenses of the customer data center identified during said profiling, and wherein the emulation service being configured for: analyzing the number of computing devices of the customer data center, the number of software licenses of the customer data center, and the computation cycles of the customer data center to determine an overall machine utilization of the customer data center, determining an efficiency value based on the overall machine utilization, and
selecting the requisite cloud resources based on the efficiency value or the overall machine utilization;
wherein the data center profiler is configured for profiling the at least portion of the customer data center through determining historical data center workload data comprising historic computation cycles experienced by the customer data center over a predetermined timeframe;
wherein the historical data center workload data comprises an average of the historic computation cycles experienced by the customer data center over the predetermined timeframe;
wherein the identified cloud resources in the emulation report comprise at least one member of a group comprising: a cloud service, pricing information, service tier, data storage type, or computing consumption for supporting the customer data center in the cloud computing environment;
wherein said emulation of the customer data center emulates either a portion of the customer data center operating in the cloud computing environment as part of a hybrid public-private network;
receiving data center parameters indicating an industry associated with the customer data center, accessing industry processing and storage requirements associated with other data centers hosted in the cloud computing environment for customers in the industry, and basing selection of the at least one cloud service for operating the customer data center on said emulation of the customer data center in the cloud computing environment and the industry processing and storage requirements;
receiving data center parameters indicating a number of data center users associated with the customer data center, accessing user-dependent processing and storage requirements associated with other data centers hosted in the cloud computing environment for customers in the industry or having the number of data center users, and basing selection of the at least one cloud service for operating the customer data center on said emulation of the customer data center in the cloud computing environment and the user-dependent processing and storage requirements;
wherein the at least one cloud service includes at least one member of a group comprising: data redundancy, block binary large object (BLOB) storage; page BLOB storage, table-and-queue data storage, storage transactions, or data import/export information associated with the customer data center;
wherein the real-time workload data of the customer data center comprise computation cycles of the customer data center at the time of said profiling of the customer data center;
wherein the real-time workload data of the customer data center comprise an indication of software licenses associated with the customer data center;
wherein real-time workload data determined through said profiling comprises computation cycles or memory storage usage of the customer data center at a point in time; and
wherein the one or more processors are further programmed: access pricing information for using the identified cloud resources, determine, conditioned on accessed pricing information for the identified cloud resources, a cost estimate for operating the customer data center in the cloud computing environment, and including the cost estimate for operating the customer data center in the cloud computing environment in the emulation report.

While the aspects of the disclosure have been described in terms of various examples with their associated operations, a person skilled in the art would appreciate that a combination of operations from any number of different examples is also within scope of the aspects of the disclosure.

### Example Operating Environment

Although described in connection with an example computing device 100, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, VR devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media typically embody computer readable instructions, data structures, program modules, or the like in a modulated data signal such as a carrier wave or other transport mechanism and include any information delivery media.

The examples illustrated and described herein, as well as examples not specifically described herein but within the scope of aspects of the disclosure, constitute exemplary means profiling and emulating a customer data center 210 in a cloud computing environment. For example, the elements described in FIG. 3, such as when encoded to perform the operations illustrated in FIGS. 4, 6, and 7, constitute exemplary means for profiling and emulating a customer data center 210 in a cloud computing environment.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. One or more computer-storage media having computer-executable instructions embodied thereon that, when executed, perform a method for emulating a customer data center in a cloud computing environment and determining cloud resources for operating the customer data center in the cloud computing environment, the one or more computer-storage media comprising:
a data center profiler for profiling at least a portion of the customer data center to determine real-time workload data of the customer data center that indicates a quantity of computation cycles associated with current operation of the portion of the customer data center;
a cloud emulator for emulating the customer data center in the cloud computing environment based on the real-time workload data of the customer data center;
a suggestion engine for identifying the cloud resources for operating the customer data center in the cloud computing environment based on said emulation of the customer data, and generating an emulation report that indicates the identified cloud resources for operating the customer data center in the cloud computing environment; and
a network component for transmitting the emulation report over a network to a user, wherein the emulation report describes features of operating the customer data center in the cloud computing environment to the user via a user interface.

2. The one or more computer-storage media of claim 1, wherein the user interface is further configured for receiving enterprise parameters indicating at least one member of a group comprising: an industry associated with the customer data center, a number of customer data center users, one or more service tiers associated with the customer data center, or a number of software licenses associated with the customer data center; and
wherein the cloud resources for operating the customer data center are selected, at least in part, based on the received enterprise parameters.

3. The one or more computer-storage media of claim 2, wherein the identified cloud computing resources include at least one member of a group comprising: data redundancy metrics, block binary large object (BLOB) storage; page BLOB storage, table storage, queue storage, or data import information, or data export information associated with the customer data center.

4. The one or more computer-storage media of claim 1, wherein the determined real-time data of the customer data center comprise an indication of a quantity or type of data storage associated with the customer data center.

5. The one or more computer-storage media of claim 1, wherein the determined real-time workload data of the customer data center comprise a number of computing devices of the customer data center identified during said profiling, and
wherein the emulation service is further configured for:
analyzing the number of computing devices of the customer data center and the computation cycles of the customer data center to determine an overall machine utilization of the customer data center,
determining an efficiency value based on the overall machine utilization, and
selecting the requisite cloud resources based on the efficiency value or the overall machine utilization.

6. The one or more computer-storage media of claim 1, wherein the determined real-time workload data of the customer data center comprise a number of computing devices and a number of software licenses of the customer data center identified during said profiling, and
wherein the emulation service being configured for:
analyzing the number of computing devices of the customer data center, the number of software licenses of the customer data center, and the computation cycles of the customer data center to determine an overall machine utilization of the customer data center,
determining an efficiency value based on the overall machine utilization, and
selecting the requisite cloud resources based on the efficiency value or the overall machine utilization.

7. The one or more computer-storage media of claim 1, wherein the data center profiler is configured for profiling the at least portion of the customer data center through determining historical data center workload data comprising historic computation cycles experienced by the customer data center over a predetermined timeframe.

8. The one or more computer-storage media of claim 8, wherein the historical data center workload data comprises an average of the historic computation cycles experienced by the customer data center over the predetermined timeframe.

9. The one or more computer-storage media of claim 1, wherein the identified cloud resources in the emulation report comprise at least one member of a group comprising: a cloud service, pricing information, service tier, data storage type, or computing consumption for supporting the customer data center in the cloud computing environment.

10. The one or more computer-storage media of claim 1, wherein said emulation of the customer data center emulates either a portion of the customer data center operating in the cloud computing environment as part of a hybrid public-private network.

11. A computerized method for emulating a customer data center in a cloud computing environment, the computerized method comprising:
receiving a request to emulate the customer data center in the cloud computing environment;
profiling the customer data center to obtain real-time workload data of the customer data center, said profiling comprising determining required processing and storage requirements needed by the customer data center based on the real-time workload data of the customer data center;
emulating the customer data center in the cloud computing environment based on the processing and storage requirements to obtain emulated workload data for operating the customer data center in the cloud computing environment, the emulated workload data comprising at least one cloud service for operating the customer data center;
generating an emulation report indicating the at least one cloud service; and
communicating the emulation report over a network to inform a user of one or more requirements for operating the customer data center in the cloud computing environment.

12. The computerized method of claim 11, wherein the real-time workload data comprises computation cycles or memory storage usage of the customer data center at a point in time.

13. The computerized method of claim 11, further comprising:
receiving data center parameters indicating an industry associated with the customer data center;
accessing industry processing and storage requirements associated with other data centers hosted in the cloud computing environment for customers in the industry; and
basing selection of the at least one cloud service for operating the customer data center on said emulation of the customer data center in the cloud computing environment and the industry processing and storage requirements.

14. The computerized method of claim 11, further comprising:
receiving data center parameters indicating a number of data center users associated with the customer data center;
accessing user-dependent processing and storage requirements associated with other data centers hosted in the cloud computing environment for customers in the industry or having the number of data center users; and
basing selection of the at least one cloud service for operating the customer data center on said emulation of the customer data center in the cloud computing environment and the user-dependent processing and storage requirements.

15. The computerized method of claim 11, wherein the at least one cloud service includes at least one member of a group comprising: data redundancy, block binary large object (BLOB) storage; page BLOB storage, table-and-queue data storage, storage transactions, or data import/export information associated with the customer data center.

16. The computerized method of claim 11, wherein the real-time workload data of the customer data center comprise computation cycles of the customer data center at the time of said profiling of the customer data center.

17. The computerized method of claim 11, wherein the real-time workload data of the customer data center comprise an indication of software licenses associated with the customer data center.

18. An emulation and suggestion system for emulating a customer data center in a cloud computing environment and suggesting at least one cloud resource for operating the customer data center in the cloud computing environment, the system comprising:
memory for storing data center parameters identifying the customer data center; and
one more processors programmed to:
profile at least a portion of the customer data center to determine real-time workload data of the customer data center,
emulate the customer data center in the cloud computing environment based on the real-time workload data of the customer data center,
identify the cloud resources for operating the customer data center in the cloud computing environment based on said emulation of the customer data center,
generate an emulation report that indicates the identified cloud resources of the cloud computing environment for operating the customer center, and
transmit the emulation report over a network so that a user can identify the cloud resources for operating the customer data center in the cloud computing environment.

19. The emulation and suggestion system of claim 18, wherein the real-time workload data determined through said profiling comprises computation cycles or memory storage usage of the customer data center at a point in time.

20. The emulation and suggestion system of claim 18, wherein the one or more processors are further programmed:
access pricing information for using the identified cloud resources,
determine, conditioned on accessed pricing information for the identified cloud resources, a cost estimate for operating the customer data center in the cloud computing environment, and
including the cost estimate for operating the customer data center in the cloud computing environment in the emulation report.
